(19) United States
(12) Patent Application Publication
(10) Pub. No.: US 2003/0063862 A1
(43) Pub. Date: Apr. 3, 2003

(54) HOLDER FOR OPTICAL LOOPBACK ASSEMBLY WITH RELEASE MECHANISM

(75) Inventors: Mark E. Fillion, Rumford, RI (US); Steve De Jordy, Providence, RI (US); Andrei A. Vankov, Mansfield, MA (US)

Correspondence Address: James J. Hill, Esq., Ste. 3000, 300 S. Wacker Dr., Chicago, IL, 60606, US

(73) Assignee: Woodhead Industries, Inc.

(21) Appl. No.: 09/968,359

(22) Filed: Oct. 1, 2001

(51) Int. Cl. G02B 6/36

(52) U.S. Cl. 385/53; 385/76

(57) ABSTRACT

A duplex holder for an optical loopback assembly includes a clip adapted to receive and hold an optical loopback assembly. The clip is mounted in an elongated cover which provides a handle for manipulating the holder. A release latch pivotally mounted to the clip engages release arms on the loopback assembly. An elongated member is pivotally connected to the release latch and extends beyond the rear end of the cover so that it is accessible by a user from the rear of the cover. When the elongated member is translated, it rotates the release latch to move the latch arm of the loopback assembly to a release position so that the loopback assembly can be removed from its associated mating connector by convenient manipulation of the holder.

### FIELD OF THE INVENTION

The present invention relates to holders for optical loopback assemblies; and in particular, it relates to a holder with a release mechanism.

### BACKGROUND OF THE INVENTION

Fiber optic cables provide a transmission medium for data in many applications, for example, in commercial Automatic Teller Machines commonly used in banks. In many cases the fiber optic cable is coupled to an electronic data storage unit. Tests are routinely made both of the storage unit and the optical cables associated with it.

In order to facilitate testing of the system or components of such a system employing fiber optic cables, it has been the practice to arrange the fiber optic cables in a bundle and extend them to a common area where the ends of the cables are provided with devices referred to as “loopback assemblies” or attenuators. A loopback assembly is a device which receives the optical signal along one path and redirects the signal back into the transmitting medium with a pre-determined attenuation level. In a “small form factor” environment, the LC connector interface is commonly used.

Some of the tasks involved on the individual fiber optic cables involve substituting loopback assemblies with differing attenuation characteristics. Typically, the fiber optic cables are grouped in pairs so that the loopback assemblies are typically provided in pairs referred to as duplex LC connectors. The LC connectors assemblies are each removably connected to an associated fiber optic cable provided with an end connector which mates with the removable LC connector or loopback assembly. A loopback assembly typically is mechanically latched to an associated mating connector using a configuration manufactured according to an industry-accepted standard.

Each loopback assembly is mechanically secured to its associated mating connector and can be disconnected by depressing a latch arm of a release mechanism. Typically, the distal or back end of a loopback assembly and its associated release latch is supported by a device which is referred to herein as a “holder” and which includes a release mechanism to actuate the latch arm of the LC connector. Specifically, the user must grasp the holder by a handle and use his or her fingers to depress a latch actuator thereby moving the latch arms on the associated LC connectors to the release position, and disengaging the LC connectors from their associated mating connectors.

There is a problem with the existing release mechanism described above in that the latch arms of the release mechanisms are located to one side of the handle, and the handles are arranged in close side-by-side relation with the latch actuator positioned immediately adjacent to another holder. This requires the user to place his or her fingers between two closely spaced holders, making it difficult to access the latch actuators and then to exert sufficient manual force to depress the latch actuator because there is insufficient room to do so.

### SUMMARY OF THE PRESENT INVENTION

The present invention is directed to a holder for an optical loopback assembly in the form of an LC connector. The illustrated embodiment includes a duplex clip adapted to receive and hold a pair of LC connectors. The clip is mounted in an elongated hollow cover which provides a handle for manipulating the holder.

A release latch is pivotally mounted to the clip. The release latch extends forwardly toward the loopback assemblies and includes a lip which engages the latch arms on the loopback assemblies. The latch arms of the loopback assemblies are biased to the latched position, as is conventional.

An elongated pull member is pivotally mounted to the release latch and extends through the cover and beyond the rear end of the cover where it may be provided with a pull-tab. The pull-tab is accessible by a user from the rear end of the cover, not the side as with the prior art described above.

When the pull member is pulled by the user, it rotates the release latch which, in turn, rotates to depress the latch arms of the loopback assemblies to unlatch or disconnect position. When the latch arms are depressed by the release latch, the loopback assemblies can be removed from their associated end connectors by convenient manipulation of the holder.

Thus, with the device of the present invention, the user may conveniently unlatch a duplex loopback assembly simply by pulling a readily accessible pull member outwardly of the end of the cover and extending longitudinally in the direction of the cover. The design obviates the need to manipulate the fingers of the user into position between tightly spaced adjacent holders.

Other features and advantages of the present invention would be apparent to persons skilled in the art from the following detailed description of a preferred embodiment accompanied by the attached drawing wherein identical reference numerals will refer to like parts in the various views.

### BRIEF DESCRIPTION OF THE DRAWINGS

FIG. 1 is an upper, frontal perspective view of a holder for duplex LC connectors constructed according to the present invention;

FIG. 2 is a front elevational view of the assembly of FIG. 1;

FIG. 3 is a vertical cross sectional view taken along the sight line 3-3 of FIG. 2;

FIG. 3A is a view similar to FIG. 3 with the release latch and actuating member in the release position;

FIG. 4 is a perspective view similar to FIG. 1 of the holder and duplex LC connectors, with the various components in exploded relation;

FIG. 5 is a perspective view taken along a sight line similar to FIG. 1 of the release latch;

FIG. 6 is a perspective view taken along a sight line somewhere to that of FIG. 1 of the pull member;

FIG. 7 is a perspective view taken along a sight line similar to that of FIG. 1 of a duplex clip incorporated into the holder of FIG. 1;

FIG. 8 is a perspective view taken along a sight line similar to that of FIG. 1 of a release tab incorporated into the device of FIG. 1;

FIG. 9 is a top view of the release tab of FIG. 8; and

FIG. 10 is a vertical cross-sectional view taken along the sight line 10-10 of FIG. 9.

### DETAILED DESCRIPTION OF THE ILLUSTRATED EMBODIMENT

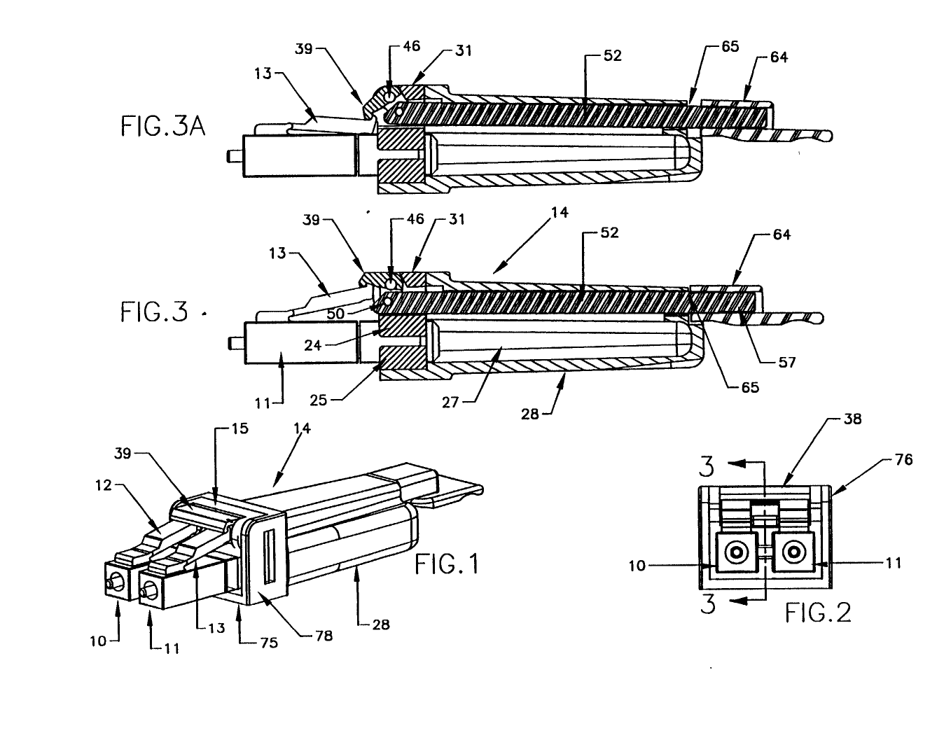

Referring first to FIGS. 1-3, reference numerals 10 and 11 refer generally to a pair of conventional loopback assemblies in the form of LC connectors 10, 11. The connectors 10, 11 are each associated with a mating connector which is also conventional and is not shown in the drawing. The mating connector or “end” connector as it is sometimes referred to, is assembled to a conventional fiber optic transmission medium.

The LC connectors 10, 11 are conventionally provided with latch arms such as those designated 12, 13 respectively. As best seen in FIG. 3, the latch arm 13 extends rearwardly and upwardly. The latch arms 12, 13 are biased to the upward position shown in FIG. 3, sometimes referred to as the latched position; and they may be depressed downwardly to a release position (seen in FIG. 3A). In the latched position, the LC connectors are rigidly connected to their associated mating connectors, and in the release position, the LC connectors may be removed rearwardly from their associated mating connectors. As used herein, the term “forward” refers to the connecting end of the LC connector, and “rear” refers to the right side of the structure shown in FIG. 3—i.e., the distal end of the holder generally designated 14.

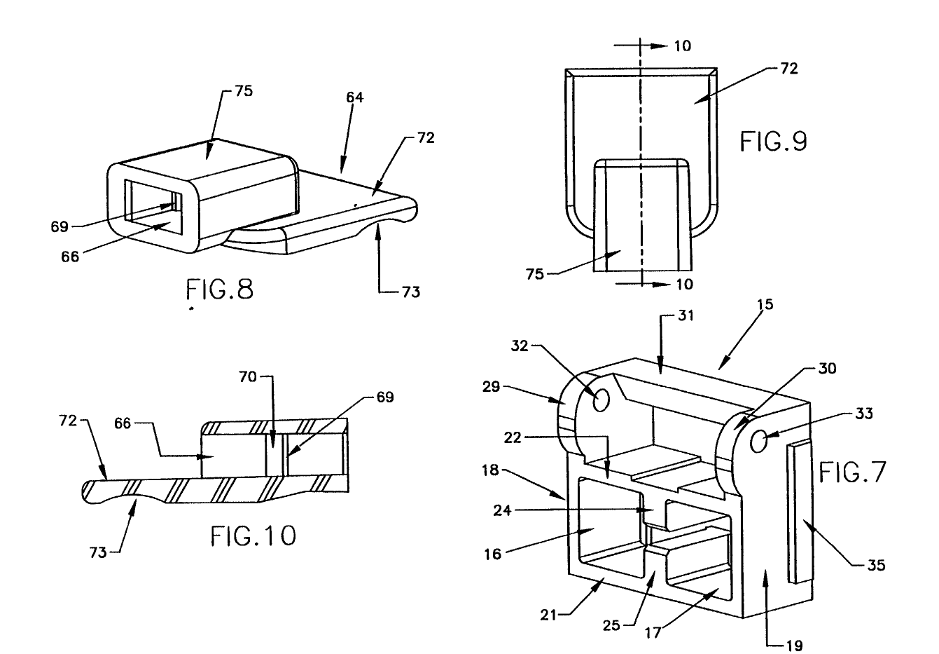

As seen in FIGS. 1, 4 and 7, a duplex clip generally designated 15 forms a pair of receptacles designated 16 and 17 respectively in FIG. 7, for receiving the rear ends of the LC connectors 10, 11 respectively. In the illustrated embodiment, the LC connectors are generally square in cross section, and the receptacles 16, 17 are sized to snugly but releaseably receive the rear end of their associated LC connector as seen in FIGS. 1 and 3. To form the receptacles 16, 17, the duplex clip 15 includes a first upright sidewall 18, a second upright sidewall 19 (see FIG. 7), a bottom wall 21, and a transverse upper wall 22. Partial wall sections 24, 25 form the adjacent sides for the receptacles 16, 17. As seen in FIG. 3, the rear ends of the LC connectors may extend beyond the rear of the duplex clip 15, and into the hollow or inner cavity 27 of a cover 28.

Returning to FIGS. 1, 4 and 7, the sidewalls 18, 19 of the duplex clip 15 extend upwardly above the wall 22 to define extensions 29, 30. The upper rear portions of the extensions 29, 30 are connected by means of a transverse brace 31. The extensions 29, 30 are provided with apertures 32, 33 respectively which are horizontally aligned to receive a pivot pin as will be described. The outer rear portions of the sidewalls 18, 19 are provided with upright, elongated ribs, the one on wall 19 being shown in FIG. 7 and designated 35. A similar rib exists on the outer surface of sidewall 18, but is not shown in FIG. 7.

Turning now to FIGS. 1, 3 and 5 in particular, a release latch generally designated 38 is pivotally mounted to the upper portion of the duplex clip 15. The release latch 38 includes a forwardly extending portion 39 which defines a lower, curved lip 40 extending across the width of the release latch 38. The lip 40 is adapted to engage the upper rear portion of the release arms 12, 13 (see FIG. 3), the release arms being provided with a corresponding upwardly extending rib which fits behind and below the lip 40 when the two are in assembled relation as seen in FIG. 3.

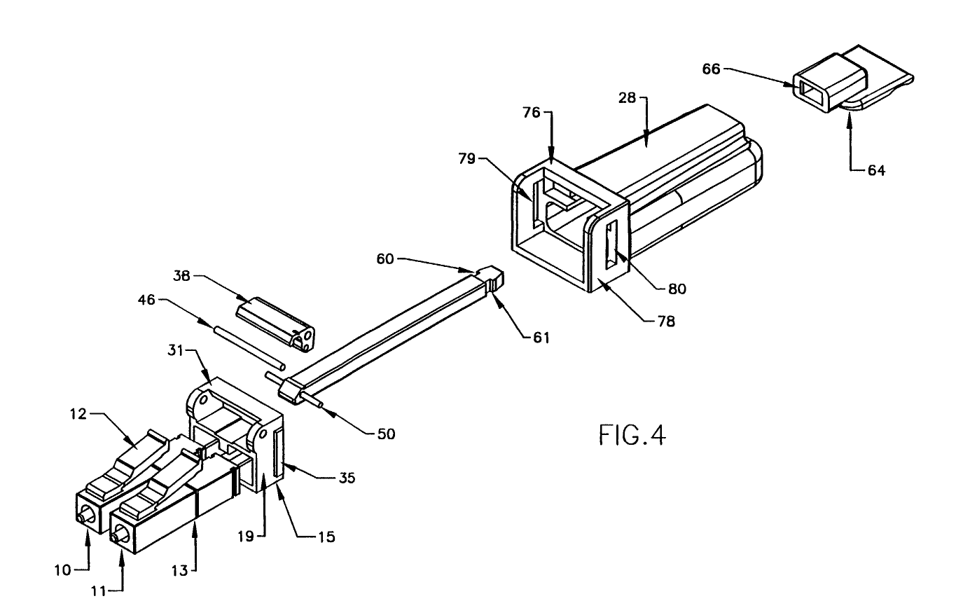

The release latch 38 also includes a right and a left lower depending lobe designated respectively 42 and 43 which are spaced to define a central space generally designated 44 in FIG. 5. Above the depending lobes 42, 43, there is a bore 45 which extends completely through the release latch 38 and receives a pin (see 46 in FIG. 4). The outboard ends of the pin 46 are received respectively in the apertures 32, 33 in the extensions 29, 30 of the sidewalls 18, 19 of the duplex clip 15. The lower portions of the lobes 42, 43 are provided with similar bores 48, 49 for receiving a second pin designated 50 in FIG. 3 which pivotally connects the forward end of a plunger or pull member generally designated 52 to the release latch 38.

Other embodiments could be designed by persons skilled in the art wherein the actuating member 52 would be pushed to rotate the release latch 38. It will be observed from FIGS. 3 and 5 that the axis of the pin 50 is below the axis of the hinge pin 46 so that when the pull member 52 is moved rearwardly by the user, the release latch 38 pivots counterclockwise in FIG. 3 about the fixed hinge pin 46, thereby rotating the forward, upper portion 39 of the release latch 38 downwardly, and depressing the release arms 12, 13 of the LC connectors 10, 11 to the release position, as seen in FIG. 3A thereby disconnecting the LC connectors from their associated mating connectors and permitting the LC connectors to be removed from the assembly through manipulation of the cover 28, using it as a handle.

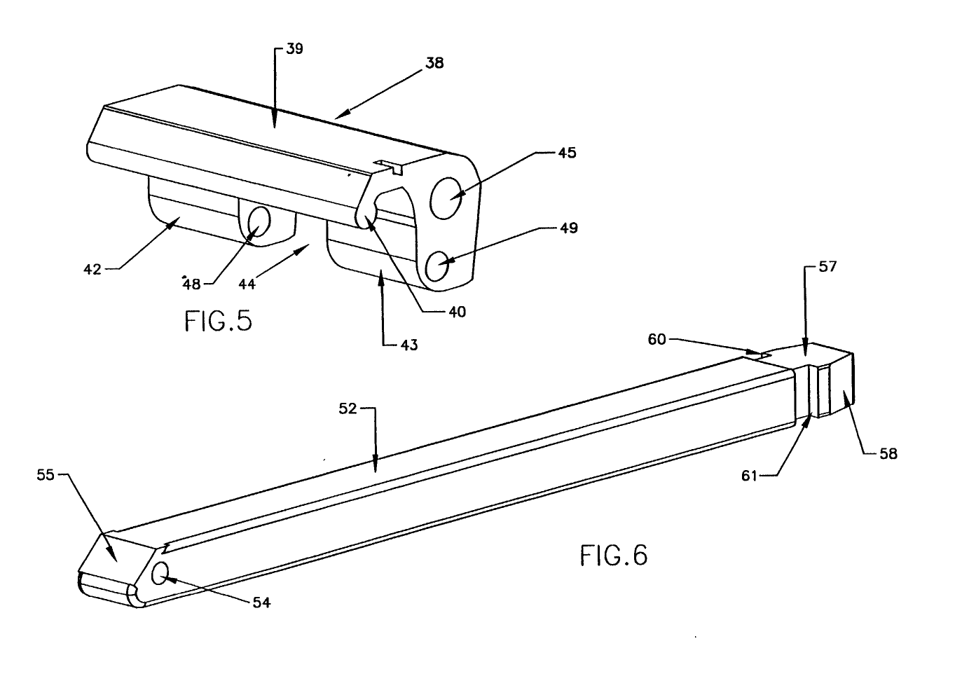

Turning now to FIGS. 3 and 6, the actuating or pull member 52 is seen in its entirety in FIG. 6. The pull member 52 includes a forward bore 54 for receiving the pivot pin 50. The forward end of the pull member 52 is shaped into a nose portion 55 to permit the release latch 38 and release arms 12, 13 of the LC connectors to rotate downwardly to the release position seen in FIG. 3A.

At the rear end of the pull member 52, there is a barbed portion 57 having inclined, lead-in surfaces such as one the designated 58 in FIG. 6, terminating at their forward ends in a pair of transverse surfaces 60, 61 which engage and lock to corresponding opposing surfaces formed in a pull-tab generally designated 64 in FIG. 4 and as will be further described presently.

As best seen in FIG. 3, the actuating member 52 extends through the hollow interior of the cover 28 and through an aperture 65 (FIG. 3) in the upper rear portion of the cover. The barbed portion 57 is then received in an opening 66 of the tab 64 (see FIGS. 4 and 8), the sides of which are each provided with an inwardly inclined ramp surface 69, at the rear of which is a transverse surface 70 for engaging and securing the corresponding surface 60 of the barbed portion 57 of the pull member 52. The tab 64 includes a grip pad 72, the lower surface of which may be curved as at 73 for placement of an index finger, with the thumb resting on the upper surface of pad 72 for manipulating the tab 64 and the pull member 52. A housing 75 is integrally molded with the finger pad 72 to provide the opening 66 receiving the barbed rear end of the actuating member 52 in secure engagement.

Returning to FIG. 4, the cover 28, at its forward portion, includes a generally rectangular seat or receptacle for receiving and securing the duplex clip 15. The seat of the cover 28, generally designated 76 includes right and left sidewalls 77, 78 which are provided with vertically elongated slots 79, 80 respectively for receiving the ribs on the duplex clip 15 and designated 35 for the left side clip of the duplex receptacle 15, thus securing the clip 15 to the cover 28.

The assembly of the components seen in FIG. 4 for the holder of the present invention will be apparent to persons skilled in the art. The duplex clip 15 is an integrally molded piece part. The release latch 38 is placed into the duplex clip 15 with the bore 45 of the release latch aligned with the side hole 32, 33 of the clip. A pin 46 is then placed through the hole 33, bore 45 and hole 32 to pivotally mount the release latch within the duplex clip. The forward portion of the pull member 52 is pivotally mounted to the release latch 38 by positioning the forward end of the pull member 52 is positioned so that the bore 54 aligns with the bores 48, 49 formed in the lobes 42, 43 of the release clip 38. A pin 50 is then inserted through the bores 48, 49 of the release latch and bore 54 adjacent to nose of the pull member 52.

The pull member 52 is then passed through housing 28 in a rearward direction until the barbed portion 57 enters the opening 66 of the pull-tab 72, and the barbs engage the latch surfaces 70. The pull-tab 64 is then fixed to the rear end of the pull member 52 in the manner described.

Persons skilled in the art will be able to modify the structure which has been illustrated and the substitute equivalent elements for those described while continuing to practice the principle of the invention. For example, the formation of the hinges described may readily be modified by persons skilled in the art, and the locations of the various components maybe modified while continuing to provide the overall functioning of the device. Moreover, the release latch 38 could be re-configured such that the axis of the hinge pins would be re-located and a pushing action on actuating member 52 would actuate the release latch, rather than a pulling motion. It is, therefore, intended that all such modifications and substitutions be covered as they are embraced within the spirit and scope of the appended claims.

I claim:

1. A holder for an optical loopback assembly including a connector having a release arm movable between a latched position and a release position, said holder comprising: a clip defining at least one receptacle for receiving a connector; an elongated handle integral with said clip and supporting the same; a pivotal release latch defining a portion engaging the release arm of a connector received in said clip; and an actuating member having a forward portion pivotally mounted to said release latch and extending in the direction of elongation of said handle and defining a free end extending free of said handle, said actuating member, handle, and release latch being arranged whereby as said actuating member is displaced longitudinally, it rotates said release member to move said release arm to said release position thereby to disengage said loopback assembly from an associated mating connector.

2. The apparatus of claim 1 wherein the pivotal connection of said release latch to said clip is spaced relative to the pivotal connection between the forward portion of said actuating member and said release latch whereby said actuating member may be pulled to rotate said release latch to depress the latch arm of an associated loopback assembly.

3. The apparatus of the claim 1 wherein said handle includes an elongated inner hollow and wherein said actuating member extends through said hollow and out a rear aperture of said cover, the rear portion of said actuating member defining a barbed portion, said apparatus further including a tab connected to said rear, free portion of said actuating member by means of said barbed portion and defining a finger pad to facilitate moving said actuating member by one hand while grasping said cover with a second hand.

4. The apparatus of claim 1 wherein said clip comprises a duplex clip defining first and second receptacles for receiving first and second loopback assemblies in duplex relation, said release latch characterized in having a portion engaging the release arms of first and second LC connectors received in said first and second receptacles respectively of said duplex clip.

5. The apparatus of claim 1 wherein one of said clip and cover defines first and second lateral ribs, and the other defines a seat for receiving said clip and first and second slots for engaging and coupling respectively to said first and second ribs of said duplex clip for securing said duplex clip to said cover.

6. The apparatus of claim 1 wherein said cover includes a seat for receiving said clip and wherein one of said clip and said seat includes at least one rib and the other includes a slot for receiving said rib to secure said clip to said seat.
